(19) United States
(12) Patent Application Publication
(10) Pub. No.: US 2008/0230292 A1
(43) Pub. Date: Sep. 25, 2008

(54) Self-Propelled Vehicle

(75) Inventor: Jan Falck-Schmidt, Odense C (DK)

Correspondence Address: JAMES C. WRAY, 1493 CHAIN BRIDGE ROAD, SUITE 300, MCLEAN, VA, 22101, US

(73) Assignee: Falck Schmidt Defence Systems A/S

(21) Appl. No.: 10/593,455

(22) PCT Filed: Mar. 18, 2005
(86) PCT No.: PCT/DK2005/000183

§ 371 Date: Feb. 2, 2007

(30) Foreign Application Priority Data
Mar. 19, 2004 (DK) PA 2004 00445

(51) Int. Cl. B64F 1/00

(52) U.S. Cl. 180/209

(57) ABSTRACT

By a self-propelled vehicle that are for example to be used for support or service works on airplanes, hereby also military airplanes, it is advantageous that a set of wheels can be lowered in at manner that makes the distance from the ground up to the bottom of the vehicle substantially larger.

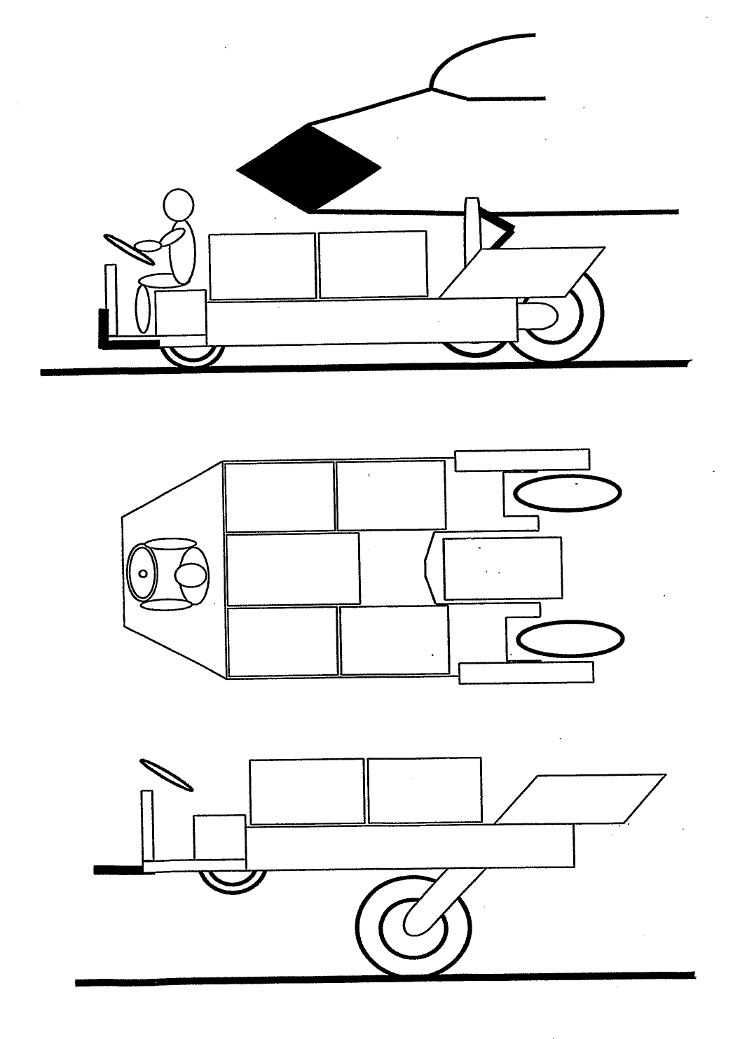

The invention relates to a self-propelled vehicle that are for example to be used for support or service works on airplanes, hereby also military airplanes, for example to ventilate the airplane, performing service on the hydraulic systems of the airplane, the power supply, loading of ammunition, tanking of fuel, towing etc.

With the ongoing development of airplanes that start and land vertically, especially military airplanes, situations will arise where airplanes will not be receiving service in an airport, but for example on a parking lot, a piece of highway etc. This means the support vehicles will have to be brought to the place in question. This is also the case with regards to peacemaking or peacekeeping missions in far away destinations. This often mean that support equipment, because of the need for a rapid intervention, will have to be moved to the area of operations by airplane. It is therefore advantageous that the vehicle comprises all the modules that are needed for support or service.

A vehicle of this kind can easily be flown to an area of operations where typically only one airplane at the time will receive service from the vehicle, and not like in a normal airport where several airplanes are receiving service from several vehicles.

When they are being used for performing service on airplanes, vehicles of this kind are preferably relatively low so that they can pass under the wings of an airplane. For this reason, the distance from the ground to the bottom of the vehicle is relatively small. In a similar way, this is also the case for rescue vehicles that has to be able to pass gates in buildings. This implies that the self-propelled vehicle is not suited to move (by itself) over big distances in terrain.

It is thus, according to the present invention advantageous that a set of wheels can be lowered so that the distance from the ground up to the bottom of the vehicle can be increased substantially.

In this manner, it will be possible to tow the vehicle as a trailer with high speed for greater distances that are also outside an outlined road.

Said set of wheels can be wheels that are also used in the self-propelling configuration, or wheels that are solely meant for use in their lowered configuration.

1. Self-propelled vehicle that are for example to be used for support or service works on airplanes, hereby also military airplanes, characterized in that a set of wheels can be lowered so that the distance from the ground up to the bottom of the vehicle can be increased substantially.
